(19) United States
(12) Patent Application Publication
(10) Pub. No.: US 2007/0135606 A1
(43) Pub. Date: Jun. 14, 2007

(54) Biocompatible surgical compositions

(75) Inventors: Nadya Belcheva, Middletown, CT (US); Ahmad R. Hadba, Wallingford, CT (US)

Correspondence Address: UNITED STATES SURGICAL,;A DIVISION OF TYCO HEALTHCARE GROUP LP, 195 MCDERMOTT ROAD, NORTH HAVEN, CT, 06473, US

(73) Assignee: Tyco Healthcare Group LP

(21) Appl. No.: 11/636,227

(22) Filed: Dec. 8, 2006

Related U.S. Application Data
(60) Provisional application No. 60/748,394, filed on Dec. 8, 2005.

(51) Int. Cl. C08G 18/00

(52) U.S. Cl. 528/44

(57) ABSTRACT

Biocompatible compositions are provided including a first polymer component including an isocyanate-functional polyalkylene oxide combined with at least one multi-isocyanate functional polyether-polyurethane, and a second component including at least one diamine.

### CROSS-REFERENCE TO RELATED APPLICATIONS

This application claims the benefit of U.S. Provisional Patent Application No. 60/748,394 filed Dec. 8, 2005, the entire disclosure of which is incorporated by reference herein.

### TECHNICAL FIELD

The present disclosure relates to biocompatible compositions capable of forming a matrix and the use of these compositions as surgical adhesives or sealants.

### BACKGROUND

In recent years there has developed increased interest in replacing or augmenting sutures with adhesive bonds. The reasons for this increased interest include: (1) the potential speed with which repair might be accomplished; (2) the ability of a bonding substance to effect complete closure, thus preventing seepage of fluids; and (3) the possibility of forming a bond without excessive deformation of tissue.

Studies in this area, however, have revealed that in order for surgical adhesives to be accepted by surgeons, they must possess a number of properties. They must exhibit high initial tack and an ability to bond rapidly to living tissue; the strength of the bond should be sufficiently high to cause tissue failure before bond failure; the adhesive should form a bridge, typically a permeable flexible bridge; and the adhesive bridge and/or its metabolic products should not cause local histotoxic or carcinogenic effects.

Several materials useful as tissue adhesives or tissue sealants are currently available. One type of adhesive that is currently available is a cyanoacrylate adhesive. However, there is the possibility that a cyanoacrylate adhesive can degrade to generate undesirable by-products such as formaldehyde. Another disadvantage with cyanoacrylate adhesives is that they can have a high flexural modulus which can limit their usefulness.

Another type of tissue sealant that is currently available utilizes components derived from bovine and/or human sources. For example, fibrin sealants are available. However, as with any natural material, variability in the material is frequently observed and, because the sealant is derived from natural proteins, there may be viral transmission concerns.

It would be desirable to provide a biological adhesive that is fully synthetic and therefore highly consistent in its properties without the concern of viral transmission. Such a composition should be flexible and biocompatible and should be suitable for use as an adhesive or sealant.

### SUMMARY

Biocompatible macromer compositions are provided which include an isocyanate-functional polyalkylene oxide combined with at least one multi-isocyanate functional polyether-polyurethane and at least one diamine. The isocyanate-functional polyalkylene oxide has pendant polyalkylene oxide groups. In embodiments, the isocyanate-functional polyalkylene oxide may be of the formula
R″(NCO)ₓ (IV)

wherein R″ is polyethylene oxide, polyethylene oxide-co-polypropylene oxide, polyethylene glycol, polypropylene glycol, or polypropylene glycol-co-polyethylene oxide copolymers, and x is a number from about 2 to about 8.

Compositions of the present disclosure may, in embodiments, include water miscible organic solvents such as alcohols, amines, amides, carboxylic acids, esters, ethers, glycols, glycol esters, glycol ethers, ketones, lactams, lactones, sulfones, organosulfides, organosulfoxides, and combinations thereof.

In embodiments, a composition of the present disclosure may include an isocyanate-functional methoxy polyethylene glycol combined with at least one multi-isocyanate functional polyether-polyurethane in a water miscible organic solvent and at least one diamine, wherein the isocyanate-functional methoxy polyethylene glycol has pendant polyethylene glycol groups.

The biocompatible macromer compositions of the present disclosure may be utilized as adhesives or sealants in a variety of applications, including medical and/or surgical applications. In embodiments, the present disclosure includes methods for closing wounds by applying a biocompatible macromer composition of the present disclosure to a wound and allowing the biocompatible macromer composition to set, thereby closing said wound. Such wounds may include, in embodiments, incisions. Compositions of the present disclosure may also be utilized to fill voids in tissue. In embodiments, compositions of the present disclosure may be utilized to adhere a medical device, such as an implant, to a surface of animal tissue.

### DETAILED DESCRIPTION

The present disclosure relates to a biocompatible macromer composition for use as a tissue adhesive or sealant, which is biocompatible, non-immunogenic and, in some embodiments, biodegradable. The biocompatible macromer composition can be employed to adhere tissue edges, seal air/fluid leaks in tissues, adhere medical devices, i.e. implants, to tissue, and for tissue augmentation such as sealing or filling voids or defects in tissue. The biocompatible macromer composition can be applied to living tissue and/or flesh of animals, including humans.

While certain distinctions may be drawn between the usage of the terms “flesh” and “tissue” within the scientific community, the terms are used interchangeably herein as referring to a general substrate upon which those skilled in the art would understand the present adhesive to be utilized within the medical field for the treatment of patients. As used herein, “tissue” may include, but is not limited to, skin, bone, neuron, axon, cartilage, blood vessel, cornea, muscle, fascia, brain, prostate, breast, endometrium, lung, pancreas, small intestine, blood, liver, testes, ovaries, cervix, colon, stomach, esophagus, spleen, lymph node, bone marrow, kidney, peripheral blood, embryonic or ascite tissue.

The composition of the present disclosure is a crosslinked macromer composition including two components. The first component is an isocyanate-functional polyalkylene oxide combined with at least one multi-isocyanate functional polyether-polyurethane. The second component of the biocompatible composition of the present disclosure includes at least one diamine. The polyalkylene oxide portion of the isocyanate-functional polyalkylene oxide is pendant and the isocyanate portion is reactive and becomes incorporated into the adhesive matrix upon cross-linking with the second component.

As noted above, the first component includes an isocyanate-functional polymer, typically a polyalkylene oxide (“PAO”). In embodiments, the isocyanate-functional polymer is a functionalized PAO such as polyethylene oxide (“PEO”), polyethylene oxide-co-polypropylene oxide (“PPO”), polyethylene glycol (“PEG”), polypropylene glycol (“PPG”), and polypropylene glycol-co-polyethylene oxide block or random copolymers.

PAOs can be functionalized to have multiple pendant groups according to any method within the purview of those skilled in the art, including, for example, methods disclosed in Chapter 22 of Poly(ethylene Glycol) Chemistry: Biotechnical and Biomedical Applications, J. Milton Harris, ed., Plenum Press, NY (1992). Various forms of PAOs, in particular PEGs, are commercially available from providers which include, for example, Shearwater Polymers, Inc., Huntsville, Ala., and Texaco Chemical Company Houston, Tex.

In one embodiment the isocyanate-functional polymer is based upon a polyalkylene oxide compound corresponding to the following formula (I):
R′_{4-z}—C—(R)_{z} (I)
wherein the R′ groups can be the same or different at each occurrence and are each individually chosen from the group consisting of —H and C₁ to C₈ alkylene groups, and the R groups can be the same or different at each occurrence and are each individually chosen from the group consisting of polyalkylene oxide groups and polyalkylene oxide groups substituted with at least one isocyanate group. In embodiments, at least two of the R groups are polyalkylene oxide groups substituted with at least one isocyanate group, and z is a number of from 2 to 4.

In other embodiments, the isocyanate-functional polymer can be a polyalkylene oxide compound corresponding to the following formula (II): 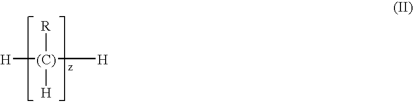
wherein the R groups are the same or different at each occurrence and are each individually chosen from the group consisting of —H, C₁ to C₈ alkylene groups, polyalkylene oxide groups and polyalkylene oxide groups substituted with at least one isocyanate group. In embodiments, z is a number from 2 to 6 and at least two of the R groups are polyalkylene oxide groups substituted with at least one isocyanate group.

In some embodiments, the isocyanate group on the isocyanate-functional polymer can have the following structure:
—[A]ᵥ—NCO (III)
wherein A is a bioabsorbable group and v is a number from about 1 to about 20. Suitable bioabsorbable groups include hydrolytically labile α-hydroxy acids such as lactic acid and glycolic acid, glycolide, lactide, lactones including ε-caprolactone, carbonates such as trimethylene carbonate, ester ethers such as dioxanones including 1,4-dioxane-2-one and 1,3-dioxane-2-one, diacids including succinnic acid, adipic acid, sebacic acid, malonic acid, glutaric acid, azelaic acid, phosphoesters such as ethyl dichlorophosphate, anhydrides such as sebacic acid anhydride and azelaic acid anhydride, etc., and combinations thereof.

In embodiments, the polyalkylene oxide may be a polyethylene oxide, such as a polyethylene glycol (“PEG”). As used herein, polyethylene glycol generally refers to a polymer with a molecular weight of less than 50,000, while polyethylene oxide is used for higher molecular weights. PEGs provide excellent water retention, flexibility and viscosity in the biocompatible macromer composition. The PEG may include a pendant alkoxy group such as methoxy, i.e., it may be a methoxy PEG (“mPEG”).

Methods for producing the isocyanate-functional polymer are within the purview of those skilled in the art. For example, PAOs can be functionalized to have multiple pendant groups according to methods including, for example, those disclosed in Chapter 22 of Poly(ethylene Glycol) Chemistry: Biotechnical and Biomedical Applications, J. Milton Harris, ed., Plenum Press, NY (1992). Various forms of PAOs, in particular PEGs, are commercially available from providers which include, for example, Shearwater Polymers, Inc., Huntsville, Ala., and Texaco Chemical Company Houston, Tex.

In one embodiment, the isocyanate-functional polyalkylene oxide of the first polymer can have the following formula
R″(NCO)ₓ (IV)

wherein R″ is a polyalkylene oxide as described above and x is a number≧1, in embodiments from about 2 to about 8. Specific examples of the isocyanate-functional polyalkylene oxide include methoxy-PEG isocyanate having the following formula

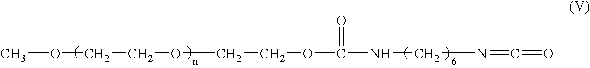

where n is a number from about 10 to about 250, and methoxy-PEG triisocyanate having the following formula

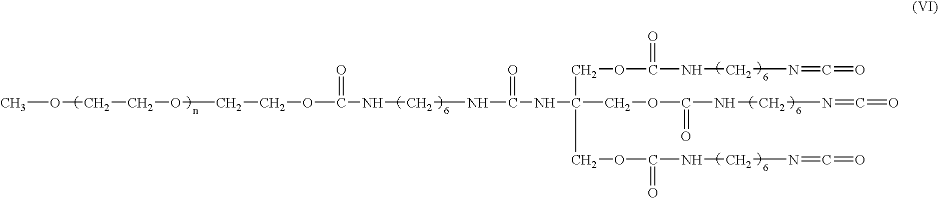

In some embodiments, the isocyanate-functional polyalkylene oxide of the first component can include at least one additional component providing hydrolytically degradable bonds, so that the isocyanate-functional polyalkylene oxide becomes biodegradable. Suitable components which can be optionally incorporated include, but are not limited to, hydrolytically labile α-hydroxy acids such as lactic acid and glycolic acid, lactide, glycolide, lactones including ε-caprolactone, carbonates such as trimethylene carbonate, ester ethers such as dioxanones including 1,4-dioxane-2-one and 1,3-dioxane-2-one, diacids including succinnic acid, adipic acid, sebacic acid, malonic acid, glutaric acid, azelaic acid, phosphoesters such as ethyl dichlorophosphate, anhydrides such as sebacic acid anhydride and azelaic acid anhydride, etc., and combinations thereof. Those skilled in the art will readily envision reaction schemes for incorporating these components into the isocyanate-functional polyalkylene oxide.

For example, these components can be incorporated into the isocyanate-functional polyalkylene oxide by reacting both the polymer and biodegradable group with small amounts of a diol. A low weight PEG polymer may be used with a diol mixture. The diol mixture results in degradable ester links between the highly branched polymer chains. A very low diol concentration should be used to prevent the polymer from gelling prematurely. The selected diol may be chosen according to the desired properties of the final biocompatible macromer composition, for example, whether it is to be utilized as an adhesive or sealant. For example, where mechanical enhancement is not desired or necessary, propylene fumarate, diethylene glycol or a short chain PEG diol can be used. Where additional strength of the sealant is desired, phthalic, biphenyl, bisphenol A, or diglycidyl ether of bisphenol A groups can be used.

In another embodiment, degradable linkages may be incorporated into the isocyanate-functional polyalkylene oxide by reacting the polyalkylene oxide with a polyhydric alcohol such as D-sorbitol, D-mannitol, sucrose, dextrose, tris(hydroxymethyl)aminomethane (also known as 2-amino-2-(hydroxymethyl)-1,3-propanediol), enterodiol, pentaerythritol, cyclodextrins, and the like to form a polyalkylene oxide having multiple hydroxy groups, i.e.,
R″—(OH)ₙ (VII)

where R″ is as defined above and n is a number from about 2 to about 20.

The polyalkylene oxide having multiple hydroxy groups may then, in turn, be reacted with a hydroxy acid such as glycolide or lactide or other bioabsorbable groups as described above to form a polyalkylene oxide having degradable groups such as poly(hydroxy) acid/hydroxy groups, wherein the degradable group can be polyglycolic acid (PGA), polylactic acid (PLA), polycaprolactone (PCL), polydioxanone (PDO), polytrimethylene carbonate (PTMC) and the like, or combinations thereof. Thus, the resulting formula can be
R″—(R₁—OH)ₙ (VIII)

where R″ is as defined above, R₁ is a degradable group, and n is a number from about 2 to about 20.

This polyalkylene oxide having multiple poly(hydroxy)acid/hydroxy groups may, in turn, be reacted with a diisocyanates to produce isocyanate-functional polyalkylene oxide having degradable linkages of formula
R″—[R₁—OCN—X—NCO]ₙ (IX)

wherein R″, R₁, X and n are as defined above.

Where present, components providing degradable linkages can be present in the isocyanate-functional polyalkylene oxide in amounts from about 5% to about 50% by weight of the isocyanate-functional polyalkylene oxide, in embodiments from about 7% to about 40% by weight of the isocyanate-functional polyalkylene oxide, typically from about 10% to about 30% by weight of the isocyanate-functional polyalkylene oxide.

In another embodiment, a low molecular weight crosslinking agent can be combined with a high molecular weight PEG to produce degradable linkages in the isocyanate-functional polyalkylene oxide. Suitable crosslinking agents include diglycolic acid, caprolactone diacid, diacid-terminal oligomers of lactides, glycolides, lactones and combinations thereof, or low molecular weight polypeptides such as poly(glutamic acid). Those skilled in the art will readily envision other reaction schemes for incorporating these components into the first polymer. See, for example, Kobayashi et al., “Water-curable and biodegradable prepolymers,” J. Biomed. Materials Res. 25:1481-1494 (1991); Kim et al., “Biodegradable photo linked-cross-linked poly(ether-ester) networks for lubricious coatings,” Biomater. 21:259-265 (2000).

In addition to or in place of components that provide hydrolytically degradable linkages, at least one linkage that is enzymatically degradable may be incorporated into the isocyanate-functional polyalkylene oxide so that it becomes biodegradable. Linkages which are enzymatically degradable include, but are not limited to: an amino acid residue such as -Arg-, -Ala-, -Ala(D)-, -Val-, -Leu-, -Lys-, -Pro-, -Phe-, -Tyr-, -Glu-, and the like; 2-mer to 6-mer oligopeptides such as -Ile-Glu-Gly-Arg-, -Ala-Gly-Pro-Arg-, -Arg-Val-(Arg)₂-, -Val-Pro-Arg-, -Gln-Ala-Arg-, -Gln-Gly-Arg-, -Asp-Pro-Arg-, -Gln(Arg)₂ -, Phe-Arg-, -(Ala)₃-, -(Ala)₂-, -Ala-Ala(D)-, -(Ala)₂-Pro-Val-, -(Val)₂-, -(Ala)₂-Leu-, -Gly-Leu-, -Phe-Leu-, -Val-Leu-Lys-, -Gly-Pro-Leu-Gly-Pro-, -(Ala)₂-Phe-, -(Ala)₂-Tyr-, -(Ala)₂-His-, -(Ala)₂-Pro-Phe-, -Ala-Gly-Phe-, -Asp-Glu-, -(Glu)₂ -, -Ala-Glu-, -Ile-Glu-, -Gly-Phe-Leu-Gly-, -(Arg)₂-; D-glucose, N-acetylgalactosamine, N-acetylneuraminic acid, N-acetylglucosamine, N-acetylmannnosamine or the oligosaccharides thereof; oligodeoxyribonucleic acids such as oligodeoxyadenine, oligodeoxyguanine, oligodeoxycytosine, and oligodeoxythymidine; oligoribonucleic acids such as oligoadenine, oligoguanine, oligocytosine, oligouridine, and the like. Those skilled in the art will readily envision reaction schemes for incorporating enzymatically degradable linkages into the isocyanate-functional polyalkylene oxide.

In embodiments, the isocyanate-functional polyalkylene oxide can have a branched or star configuration for improved biodegradability.

The molecular weight of the isocyanate-functional polyalkylene oxide can be from about 500 to about 20,000, in embodiments from about 750 to about 10,000, typically from about 1000 to about 5000.

Selection of the pendant polyalkylene oxide moieties of the isocyanate-functional polyalkylene oxide provides control of the hydrophilicity of the biocompatible macromer composition and the degree to which it will swell in situ, without sacrificing any physical or mechanical properties. Moreover, where desired, the hydrophilicity of the pendant polyalkylene oxide moiety can be utilized to reduce cell adhesion and protein deposition with the biocompatible macromer composition of the present disclosure.

The remainder of the first component of the biocompatible macromer composition of the present disclosure includes at least one multiisocyanate polyether-polyurethane. Suitable polyether-polyurethanes can be formed using methods known to those skilled in the art. In one embodiment, difunctional polyethers which are capable of reaction with isocyanate groups, for example polyether polyols such as polyether-diols, may be utilized. The difunctional polyethers may be reacted with symmetrical diisocyanates and short-chain, low-molecular-weight diols to produce elastomeric polymers having both hard and soft segments. Further details on this type of synthesis is given, for example, in “Polyurethanes”, Chapter 4.3; Ullmann's Encyclopedia of Industrial Chemistry, Sixth Edition, 2000 Electronic Release.

Examples of polyether polyols which may be utilized to produce multiisocyanate polyether-polyurethanes include the polyaddition products of styrene oxides, alkylene oxides such as ethylene oxide, propylene oxide, and butylene oxide, tetrahydrofuran, epichlorohydrin, and their co-addition and graft products, as well as polyether polyols obtained by condensation of polyhydric alcohols or mixtures thereof and by alkoxylation of polyhydric alcohols, amines and aminoalcohols.

In some embodiments, useful polyether polyols may be substantially linear compounds corresponding to the general structural formula HO—D—OH, wherein D represents the organic residue of a polyether linkage. These polyether-diols can be homopolymers comprising identical D groups or copolymers or block copolymers having different D groups in one molecule. The D groups can, in one embodiment, be divalent radicals derived from ethylene, propylene or butylene. The polyether-diols can be obtained in a manner known to those skilled in the art by polymerization of ethylene oxide, propylene oxide or butylene oxide with compounds which have active hydrogen atoms available, for example, water or alcohols. The polyether-diols can also be prepared by polymerization of cyclic ethers, for example tetrahydrofuran.

In other embodiments, polyether-diols having additional functional groups may be utilized. Examples include carbonate groups obtained by reaction of polyalkylene oxides with phosgene. However, the amount of additional units of functional groups should generally not exceed 5 mol %, based on the total amount of functional group units.

Polyether-polyurethanes are commercially available. The mean molecular weight M_{w} (weight average) of the polyether-polyurethanes employed may be from about 20,000 to about 200,000 g/mol, in embodiments from about 20,000 to about 150,000 g/mol, typically from about 30,000 to about 130,000 g/mol.

In some embodiments, mixtures of two or more different polyether-polyurethanes may be utilized.

Suitable diisocyanates for use in producing the multiisocyanate polyether-polyurethane in accordance with the present disclosure include, but are not limited to, aromatic, aliphatic and alicyclic isocyanates. Examples include, but are not limited to, aromatic diisocyanates such as 2,4-toluene diisocyanate, 2,6-toluene diisocyanate, 2,2′-diphenylmethane diisocyanate, 2,4′-diphenylmethane diisocyanate, 4,4′-diphenylmethane diisocyanate, diphenyldimethylmethane diisocyanate, dibenzyl diisocyanate, naphthylene diisocyanate, phenylene diisocyanate, xylylene diisocyanate, 4,4′-oxybis(phenylisocyanate) or tetramethylxylylene diisocyanate; aliphatic diisocyanates such as tetramethylene diisocyanate, hexamethylene diisocyanate, lysine diisocyanate, 2-methylpentane-1,5-diisocyanate, 3-methylpentane-1,5-diisocyanate or 2,2,4-trimethylhexamethylene diisocyanate; and alicyclic diisocyanates such as isophorone diisocyanate, cyclohexane diisocyanate, hydrogenated xylylene diisocyanate, hydrogenated diphenylmethane diisocyanate, hydrogenated trimethylxylylene diisocyanate, 2,4,6-trimethyl 1,3-phenylene diisocyanate or commercially available DESMODURS® from Bayer Material Science.

The isocyanate-functional polyalkylene oxide combined with the at least one multiisocyanate polyether-polyurethane can be delivered either as neat liquids, i.e., not diluted or mixed with other additives, or they may be dissolved in a bioacceptable water miscible organic solvent. Suitable water miscible organic solvents include alcohols, such as methyl alcohol, ethyl alcohol, n-propyl alcohol, isopropyl alcohol, n-butyl alcohol, sec-butyl alcohol, or tert-butyl alcohol; amines, such as morpholine and ethanolamine; amides, such as dimethyl formamide or dimethylacetamide; carboxylic acids; esters, such as ethyl acetate, ethyl lactate, and ethylene carbonate; ethers, such as tetrahydrofuran or dioxane; glycerine; glycols; glycol esters; glycol ethers; ketones, such as acetone, diacetone, or methyl ethyl ketone; lactams, such as N-isopropylcaprolactam or N-ethylvalerolactam; lactones, such as butyrolactone; sulfones, such as dimethylsulfone; organosulfides; organosulfoxides, such as dimethyl sulfoxide or tetramethylene sulfoxide; and derivatives thereof and combinations thereof. Among these organic solvents, dimethyl formamide, ethyl lactate, and combinations thereof may be utilized in some embodiments.

The ratio of isocyanate-functional polyalkylene oxide to multiisocyanate polyether-polyurethane in the first component can be from about 1:99 to about 99:1, in embodiments from about 2:98 to about 75:25, typically from about 5:95 to about 25:75.

The first component, i.e., the combination of isocyanate-functional polyalkylene oxide and multiisocyanate polyether-polyurethane, may be present in the biocompatible macromer composition of the present disclosure in amounts from about 50% to about 99% by weight of the biocompatible macromer composition, in embodiments from about 55% to about 95% by weight of the biocompatible macromer composition, typically from about 60% to about 90% by weight of the biocompatible macromer composition.

The second component of the biocompatible macromer composition of the present disclosure is a diamine. Suitable diamines which may be utilized in accordance with the present disclosure include, aromatic diamines and polyether diamines. Specific examples of suitable diamines include, but are not limited to, ethylene diamine, hexamethylene diamine, isomers of hexamethylene diamine, N,N′-Bis(3-aminopropyl)-1,2-ethane diamine, N-(3-Aminopropyl)-1,3-propane diamine, N-(2-aminoethyl)-1,3 propane diamine, cyclohexane diamine, isomers of cyclohexane diamine, and isophorone diamine.

In some embodiments aromatic diamines may be used as the diamine including m-phenylene diamine, p-phenylene diamine, m-xylylene diamine, toluene diamine, and 4-methoxy-1,3-phenyldiamine. In other embodiments, polyether diamines may be utilized as the diamine including 4,9-dioxadodecane-1,12-diamine, 4,7,10-trioxatridecane-1,12-diamine, and bis(3-amino propyl)polytetrahydrofurans. In embodiments, combinations of the foregoing diamines may be utilized.

The second component of the present disclosure may be in a solution. This solution can be prepared by simply adding the diamine to water and heating with stirring. The temperature to which the solution is heated should be sufficient to cause the diamine to go into solution, but insufficient to cause degradation of the diamine. Typically, the solution will be heated to a temperature of from about 0° to about 100° C. The solvent employed to make the first solution may be a pharmaceutically acceptable solvent and can, in some embodiments, be water. Additional solvents which may be used include diols, polyols, mineral oil, and isotonic solutions such as Ringer's solution. The above solvents may be used alone or in combination with another solvent as a co-solvent. The amount of the diamine added to the solvent depends on the particular diamine and solvent employed but generally can be from about 50 to about 500 grams per liter. The amount of diamine added should be insufficient to cause precipitation of the diamine upon cooling of the solution to room temperature.

The second component of the biocompatible macromer composition of the present disclosure, i.e., the diamine component, accelerates the curing reaction and reduces the formation of bubbles in the gel matrix caused by carbon dioxide elution, thereby reducing defects in the final biocompatible macromer composition and enhancing the physical and mechanical properties of the biocompatible macromer composition.

The second component may be present in the biocompatible macromer composition of the present disclosure in amounts from about 1% to about 50% by weight of the biocompatible macromer composition, in embodiments from about 5% to about 45% by weight of the biocompatible macromer composition, typically from about 10% to about 40% by weight of the biocompatible macromer composition.

The concentrations of the first component and the second component in the final biocompatible composition will vary depending upon a number of factors, including the types and molecular weights of the particular components used and the desired end use application, i.e., an adhesive or sealant.

As noted above, the first component is introduced in situ either as a neat liquid or in a bioacceptable water miscible solvent. The second component is introduced in situ in solution, in embodiments an aqueous solution. The two components cross-link in situ when mixed together to form the biocompatible macromer composition of the present disclosure. This biocompatible macromer composition rapidly forms a three dimensional gel-like matrix, which reduces total surgical/operating time during a medical procedure.

Where degradable linkages are included in the isocyanate-functional polymer of the first component, the biocompatible macromer composition of the present disclosure is biodegradable. The biocompatible macromer composition can also act as a drug carrier, allowing controlled release and direct delivery of a drug to a specific location in an animal, especially a human. Each component may be synthetic to reduce or eliminate immuno-reactions in a subject's tissue.

The resulting biocompatible composition can be used in a medical/surgical capacity, in place of, or in combination with, sutures, staples, clamps and the like. In embodiments, the biocompatible composition can be used to seal or adhere delicate tissue together, such as lung tissue, in place of conventional tools that may cause mechanical stress. The resulting composition can also be used to seal air and/or fluid leaks in tissue as well as to prevent post-surgical adhesions and to fill voids and/or defects in tissue.

The use of higher concentrations of both the first and second components will result in the formation of a more tightly crosslinked biocompatible composition, producing a stiffer and stronger gel matrix. As such, biocompatible macromer compositions of the present disclosure intended for use in tissue augmentation will generally use higher concentrations of both the first and second components. Biocompatible macromer compositions of the present disclosure intended for use as bioadhesives or for the prevention of post-surgical adhesions need not be as firm and may therefore contain lower concentrations of the two components.

Where the biocompatible macromer composition is intended for delivery of a negatively charged compound, such as a drug or protein, the amounts of the first and second components can be adjusted accordingly. The first component, i.e., the isocyanate-functional polyalkylene oxide combined with at least one multi-isocyanate functional polyether-polyurethane, should be present in molar excess as compared to the second component, i.e., the at least one diamine, to form a positively charged matrix, which is then reacted with a negatively charged compound. In a general method for preparing a matrix for the delivery of a positively charged compound, the second component should be present in molar excess in comparison to the first component, to form a negatively charged matrix. The negatively charged matrix can then be reacted with a positively charged compound. In either case, the biocompatible macromer composition of the present disclosure will react with and lock in the charged compound within the matrix formed by the first and second components, which can then be released as the matrix degrades in vivo.

Biologically active agents may be included in the compositions of the present disclosure. For example, naturally occurring polymers, including proteins such as collagen and derivatives of various naturally occurring polysaccharides such as glycosaminoglycans, can be incorporated into the composition of the present disclosure. When these other biologically active agents also contain functional groups, the groups will react with the functional groups on the first and/or second components of the adhesive composition of the present disclosure.

A variety of optional ingredients including medicinal agents may also be added to the biocompatible macromer composition of the present disclosure. A phospholipid surfactant that provides antibacterial stabilizing properties and helps disperse other materials in the adhesive composition may be added to the composition of the present disclosure. Additional medicinal agents include antimicrobial agents, colorants, preservatives, or medicinal agents such as, for example, protein and peptide preparations, antipyretic, antiphlogistic and analgesic agents, anti-inflammatory agents, vasodilators, antihypertensive and antiarrhythmic agents, hypotensive agents, antitussive agents, antineoplastics, local anesthetics, hormone preparations, antiasthmatic and antiallergic agents, antihistaminics, anticoagulants, antispasmodics, cerebral circulation and metabolism improvers, antidepressant and antianxiety agents, vitamin D preparations, hypoglycemic agents, antiulcer agents, hypnotics, antibiotics, antifungal agents, sedative agents, bronchodilator agents, antiviral agents and dysuric agents.

Imaging agents such as iodine or barium sulfate, or fluorine, can also be combined with the composition of the present disclosure to allow visualization of the surgical area through the use of imaging equipment, including X-ray, MRI, and CAT scan.

Additionally, an enzyme may be added to the composition of the present disclosure to increase its rate of degradation. Suitable enzymes include, for example, peptide hydrolases such as elastase, cathepsin G, cathepsin E, cathepsin B, cathepsin H, cathepsin L, trypsin, pepsin, chymotrypsin, γ-glutamyltransferase (γ-GTP) and the like; sugar chain hydrolases such as phosphorylase, neuraminidase, dextranase, amylase, lysozyme, oligosaccharase and the like; oligonucleotide hydrolases such as alkaline phosphatase, endoribonuclease, endodeoxyribonuclease and the like.

The biocompatible macromer composition of the present disclosure can be used for a number of different human and animal medical applications including, but not limited to, wound closure (including surgical incisions and other wounds), adhesives for medical devices (including implants), sealants and void fillers, and embolic agents. These compositions may be used to bind tissue together either as a replacement of, or as a supplement to, sutures, staples, tapes and/or bandages. Use of the disclosed compositions can eliminate or substantially reduce the number of sutures normally required during current practices, and eliminate the subsequent need for removal of staples and certain types of sutures and thus can be particularly useful for use with delicate tissues where sutures, clamps or other conventional tissue closure mechanisms may cause further tissue damage.

Additional applications include sealing tissues to prevent or control blood, or other fluid leaks, at suture or staple lines. In another embodiment, the adhesive composition can be used to attach skin grafts and position tissue flaps during reconstructive surgery. In still another embodiment, the biocompatible macromer composition can be used to close tissue flaps in periodontal surgery.

The biocompatible macromer composition can be dispensed from a conventional adhesive dispenser, which typically provides mixing of the first and second components prior to the dispenser. Such dispensers are disclosed, for example, in U.S. Pat. Nos. 4,978,336, 4,361,055, 4,979,942, 4,359,049, 4,874,368, 5,368,563, and 6,527,749, the disclosures of which are incorporated herein by reference.

In other embodiments, especially where the biocompatible macromer composition of the present disclosure is to be utilized as a void filler or sealant to fill a defect in an animal's body, it may be advantageous to more precisely control the conditions and extent of cross-linking; in such a case, it may be desirable to partially cross-link the composition prior to its use to fill a void in animal tissue. In such a case the composition of the present disclosure is applied to the void or defect and allowed to set, thereby filling the void or defect.

To effectuate the joining of two tissue edges, the two edges are approximated, and the first component, i.e., the isocyanate-functional polyalkylene oxide combined with at least one isocyanate-functional polyalkylene oxide combined with multiisocyanate polyether-polyurethane, is combined with the second component, i.e., the at least one diamine. The two components crosslink rapidly, generally taking less than one minute. It is also believed that the isocyanate/amine groups of the two components adhere to tissue by linking directly to amine groups present on the tissue surface. In this case the composition of the present disclosure can be used as an adhesive to close a wound, including a surgical incision. In such a case, the composition of the present disclosure can be applied to the wound and allowed to set, thereby closing the wound.

In another embodiment, the present disclosure is directed to a method for using the biocompatible composition of the present disclosure to adhere a medical device to tissue, rather than secure two edges of tissue. In some embodiments, depending on the composition of the medical device, a coating may be required on the medical device. In some cases such a coating can include the first component of the biocompatible composition of the present disclosure, or the second component. In some aspects, the medical device includes an implant. Other medical devices include, but are not limited to, pacemakers, stents, shunts and the like. Generally, for adhering a device to the surface of animal tissue, the composition of the present disclosure can be applied to the device, the tissue surface or both. The device, biocompatible macromer composition, and tissue surface are then brought into contact with each other and the composition is allowed to set, thereby adhering the device and surface to each other.

The present biocompatible macromer composition can also be used to prevent post surgical adhesions. In such an application, the biocompatible macromer composition is applied and cured as a layer on surfaces of internal tissues in order to prevent the formation of adhesions at a surgical site during the healing process. In addition to the formation of adhesion barriers, in embodiments the biocompatible macromer composition may be utilized to form implants such as gaskets, buttresses, or pledgets for implantation.

When used as a sealant, the composition of the present disclosure can be used in surgery to prevent or inhibit bleeding or fluid leakage both during and after a surgical procedure. It can also be applied to prevent air leaks associated with pulmonary surgery. The sealant is applied directly to the desired area in at least an amount necessary to seal off any defect in the tissue and seal off any fluid or air movement.

Application of the biocompatible macromer composition, with or without other additives, can be done by any conventional means. These include dripping, brushing, or other direct manipulation of the adhesive on the tissue surface, or spraying of the adhesive to the surface. In open surgery, application by hand, forceps or the like is contemplated. In endoscopic surgery, the biocompatible macromer composition can be delivered through the cannula of a trocar, and spread at the site by any device known in the art.

The present biocompatible macromer composition has a number of advantageous properties. The resulting biocompatible macromer composition of the present disclosure is safe and biocompatible, possesses enhanced adherence to tissue, is biodegradable, has hemostatic potential, has low cost, and are easy to prepare and use. By varying the selection of the polymer components, the strength and elasticity of the composition can be controlled, as can the gelation time.

The biocompatible macromer composition rapidly forms a compliant gel matrix, which insures stationary positioning of tissue edges or implanted medical devices in the desired location and lowers overall required surgical/application time. The biocompatible macromer composition exhibits little or no swelling upon gel matrix formation, and therefore retains the positional integrity of the aligned tissue edges and/or location of a medical device. The biocompatible macromer composition forms strong cohesive bonds, based in part on a low percent of water content as compared to other adhesives. It exhibits excellent mechanical performance and strength, while retaining the necessary pliability to adhere living tissue. This strength and pliability allows a degree of movement of tissue without shifting the surgical tissue edge. Additionally, the biocompatible macromer composition is biodegradable, allowing the degradation components to pass safely through the subject's body.

It will be understood that various modifications may be made to the embodiments disclosed herein. Therefore the above description should not be construed as limiting, but merely as exemplifications of typical embodiments. Those skilled in the art will envision other modifications within the scope and spirit of the claims appended hereto.

What is claimed is:

1. A biocompatible composition comprising:
an isocyanate-functional polyalkylene oxide combined with at least one multi-isocyanate functional polyether-polyurethane; and
at least one diamine,
wherein the isocyanate-functional polyalkylene oxide has pendant polyalkylene oxide groups.

2. A composition as in claim 1, wherein the isocyanate-functional polyalkylene oxide is of the formula
R″(NCO)ₓ (IV)
wherein R″ is selected from the group consisting of polyethylene oxide, polyethylene oxide-co-polypropylene oxide, polyethylene glycol, polypropylene glycol, and polypropylene glycol-co-polyethylene oxide copolymers, and x is a number from about 2 to about 8.

3. A composition as in claim 2, wherein R″ includes a pendant alkoxy group.

4. A composition as in claim 1, wherein the isocyanate-functional polyalkylene oxide comprises isocyanate-functional methoxy polyethylene glycol.

5. A composition as in claim 1, wherein the isocyanate-functional polyalkylene oxide combined with at least one multi-isocyanate functional polyether-polyurethane further comprises a water miscible organic solvent selected from the group consisting of alcohols, amines, amides, carboxylic acids, esters, ethers, glycols, glycol esters, glycol ethers, ketones, lactams, lactones, sulfones, organosulfides, organosulfoxides, and combinations thereof.

6. A composition as in claim 1, wherein the at least one diamine is selected from the group consisting of aromatic diamines and polyether diamines.

7. A composition as in claim 1, wherein the isocyanate-functional polyalkylene oxide includes degradable linkages.

8. A composition as in claim 1, wherein the composition further comprises a component selected from the group consisting of biologically active agents, medicinal agents, and enzymes.

9. A method for closing a wound comprising:
applying the composition of claim 1 to said wound; and
allowing the composition to set thereby closing said wound.

10. The method of claim 9 wherein the wound is a surgical incision.

11. A method for filling a void in animal tissue comprising:
applying the composition of claim 1 to said void; and
allowing the composition to set thereby filling said void.

12. A method for adhering a medical device to a surface of animal tissue comprising the steps of:
applying the composition of claim 1 to said device, said surface or both;
bringing the device, composition and surface into contact with each other; and
allowing the composition to set thereby adhering the device and surface to each other.

13. The method of claim 12 wherein said medical device is an implant.

14. A biocompatible composition comprising:
an isocyanate-functional methoxy polyethylene glycol combined with at least one multi-isocyanate functional polyether-polyurethane in a water miscible organic solvent; and
at least one diamine,
wherein the isocyanate-functional methoxy polyethylene glycol has pendant polyethylene glycol groups.

15. A composition as in claim 14, wherein the water miscible organic solvent is selected from the group consisting of dimethyl formamide, ethyl lactate and combinations thereof.

16. A composition as in claim 14, wherein the at least one diamine is selected from the group consisting of ethylene diamine, hexamethylene diamine, N,N′-Bis(3-aminopropyl)-1,2-ethane diamine, N-(3-Aminopropyl)-1,3-propane diamine, N-(2-aminoethyl)-1,3 propane diamine, cyclohexane diamine, isophorone diamine, m-phenylene diamine, p-phenylene diamine, m-xylylene diamine, toluene diamine, 4-methoxy-1,3-phenyldiamine, 4,9-dioxadodecane-1,12-diamine, 4,7,10-trioxatridecane-1,12-diamine, bis(3-amino propyl)polytetrahydrofurans, and combinations thereof.

17. A composition as in claim 14, wherein the isocyanate-functional polyalkylene oxide includes degradable linkages.

18. A composition as in claim 17, wherein the composition further comprises a component selected from the group consisting of biologically active agents, medicinal agents, and enzymes.

19. A method for closing a wound comprising:
applying the composition of claim 14 to said wound; and
allowing the composition to set thereby closing said wound.

20. The method of claim 19 wherein the wound is a surgical incision.

21. A method for filling a void in animal tissue comprising:
applying the composition of claim 14 to said void; and
allowing the composition to set thereby filling said void.

22. A method for adhering a medical device to a surface of animal tissue comprising the steps of:
applying the composition of claim 14 to said device, said surface or both;
bringing the device, composition and surface into contact with each other; and
allowing the composition to set thereby adhering the device and surface to each other.

23. The method of claim 22 wherein said medical device is an implant.
